(19) United States
(12) Patent Application Publication
(10) Pub. No.: US 2017/0345528 A1
(43) Pub. Date: Nov. 30, 2017

(54) Cable or cable accessory comprising a fire-resistant layer

(71) Applicant: NEXANS, Courbevoie (FR)

(72) Inventors: Franck GYPPAZ, Lyon (FR); Thierry AUVRAY, Lyon (FR)

(21) Appl. No.: 15/533,882

(22) PCT Filed: Dec. 8, 2015
(86) PCT No.: PCT/FR2015/053372

§ 371 Date: Jun. 7, 2017

(30) Foreign Application Priority Data
Dec. 10, 2014 (FR) 14 62188

(51) Int. Cl. H01B 7/295; C04B 28/00; H01B 13/06; H01B 3/14; H01B 3/30; C04B 16/06; C04B 24/18; H01B 3/48; C04B 111/28; C04B 103/22; C04B 111/00; C04B 111/80; C04B 111/92

(52) U.S. Cl. CPC H01B 7/295; C04B 24/18; C04B 28/008; H01B 13/06; H01B 3/14; H01B 3/30; H01B 3/48; C04B 16/0633; C04B 2103/22; C04B 2111/00482; C04B 2111/00844; C04B 2111/802; C04B 2111/92; C04B 2111/28

(57) ABSTRACT

The invention relates to a device comprising a cable and/or a cable accessory, said cable and/or cable accessory containing at least one insulating and fire-resistant layer, as well as to a method for manufacturing a cable and/or accessory of said type.

The present invention relates to a device comprising a cable and/or a cable accessory, said cable and/or cable accessory comprising at least one insulating and fire-resistant layer, as well as to a method for manufacturing a cable and/or accessory of said type.

It applies typically, but not exclusively, to the fields of electric cables and/or data-transmission cables, in particular fire-resistant safety cables, notably halogen-free, able to function for a specified length of time in fire conditions, without propagating the fire or generating large amounts of smoke, as well as to their accessories such as joints and/or terminations. These safety cables are in particular medium-voltage power transmission cables (notably from 6 to 45-60 kV) or low-frequency transmission cables, such as control cables or signaling cables.

A power cable and/or telecommunications cable is a cable intended for the transmission of electrical energy and/or for data transmission. Conventionally it comprises one or more insulated conductors, or in other words one or more elongated electrical conductor(s) surrounded by at least one insulating layer. The insulating layer may typically be an electrically insulating polymer layer in physical contact with the electrical conductor or conductors. Said insulated conductor(s) are surrounded by an outer protective sheath intended to provide mechanical protection of the insulated conductor or conductors. In certain cable designs, there is only a single layer that provides the two functions of electrical insulation and protective sheath.

The materials generally used to form the insulating layer and/or said protective sheath are generally composite materials based on polymers, in particular silicone polymers, and various additives, notably reinforcing fillers such as silica and fireproofing fillers intended to improve their fire resistance.

Despite the presence of these fillers, the fire resistance of these insulating layers is not always entirely satisfactory.

In order to make one or more cables fire-resistant, it has also already been proposed, notably in patent application EP-A1-2 760 030, to cover said cables with an electrically insulating layer comprising several superposed insulating tapes comprising mica and glass fiber, and a polymer binder (e.g. polyorganosiloxane) in contact with each of said insulating tapes. However, the cost of production of said electrically insulating layer is high (i.e. very long manufacturing time), and it is bulky.

Cement is a pulverulent mineral material that forms a cement binder paste with water or with a saline solution, capable of agglomerating various substances as it hardens. Hardening takes place by simple hydration of calcium aluminates and calcium silicates and the cement binder paste retains its strength and stability after hardening. This cement binder paste is also called cementing material. Cements are classified according to standard EN-197-1-2000 in five main families: Portland cement (CEM I), Portland composite cement (CEM II), blast-furnace cement (CEM III), pozzolanic cement (CEM IV) and composite cement or slag and ash cement (CEM V). White cement is a Portland cement without metal oxide. Artificial cement is generally obtained by burning mixtures of silica, alumina, carbonate of lime, and optionally metal oxides such as iron oxide.

Geopolymers are regarded as alternative binders that may replace the aforementioned cement materials. Geopolymers are essentially mineral chemical compounds or mixtures of compounds consisting of units of the silico-oxide (—Si—O—Si—O—), silico-aluminate (—Si—O—Al—O—), ferro-silico-aluminate (—Fe—O—Si—O—Al—O—), or alumino-phosphate (—Al—O—P—O—) type, created by a process of geopolymerization (i.e. polycondensation). The geopolymers may be used alone or mixed with organic polymers, mineral fibers, metal fibers, or organic fibers (e.g. glass fibers, ceramic fibers, etc.), carbon fibers, graphite fibers, etc., depending on the type of application required. Geopolymers are generally capable of polymerizing and hardening at room temperature (geopolymer cements). It is also possible to speed up polymerization and therefore hardening of the geopolymers by subjecting them to thermal treatment.

The commonest geopolymers are those based on aluminosilicates, designated by the term “poly(sialate)” [or “poly(silico-oxo-aluminate” or (—Si—O—Al—O—)ₙ with n denoting the degree of polymerization]. These aluminosilicate geopolymers result from the polycondensation of oligomers of the oligo(sialate) type formed from a mixture of at least one aluminosilicate, an alkaline reagent (e.g. sodium silicate or potassium silicate) and water. The geopolymers based on aluminosilicates have been classified in three groups as a function of the Si/Al atomic ratio, which may be equal to 1, 2 or 3. They are divided into poly(sialates) corresponding to the formula Mₙ(—Si—O—Al—O—)ₙ or (M)-PS, the poly(sialate-siloxos) corresponding to the formula Mₙ(—Si—O—Al—O—Si—O—)ₙ or (M)-PPS, and the poly(sialate-disiloxos) corresponding to the formula Mₙ(—Si—O—Al—O—Si—O—Si—O—)ₙ or (M)-PSDS, with M representing at least one alkali-metal or alkaline-earth cation such as K, Na, or Li or Cs and n denoting the degree of polymerization.

The geopolymer cements are used in numerous applications: design of novel materials in the fields of civil engineering and construction, creation of sculptures, manufacture of partitions and fire doors for protection against fires, and quite recently as the structure of the “black box” on board aircraft.

As an example, patent application U.S. Pat. No. 6,831,118 describes a flexible fireproof panel comprising a matrix of a plastic (e.g. flexible elastic polyurethane) and an inorganic filler (e.g. geopolymer granules) which can be used for fire protection of openings in walls, as well as cable passages.

Compositions of the ceramic type are also known for filling and sealing cable passages so as to prevent spread of a fire from room to room. In particular, patent application JP2013-060543 describes a composition comprising from 25 to 65 wt % of a solution of sodium silicate (also called “waterglass”); from 10 to 45 wt % of magnesium hydroxide or aluminum hydroxide; from 10 to 45 wt % of inert filler such as talc; and from 2 to 10% of a dispersion of microparticles of rubber (e.g. styrene-butadiene) in an aqueous medium, said dispersion comprising from 30 to 60 wt % of said microparticles. This composition is not, however, suitable as an insulating and fire-resistant layer in a cable.

Consequently, no document in the prior art describes an electric cable or data transmission cable or an accessory thereof comprising an insulating and fire-resistant layer based on a geopolymer composition or material. Moreover, the solutions proposed are not necessarily compatible with maintaining the good mechanical and dielectric properties of the protective materials.

The aim of the present invention is to overcome the drawbacks of the techniques of the prior art by proposing, at an advantageous cost, a power cable and/or telecommunications cable and/or a cable accessory displaying good fire resistance while having good mechanical properties and an advantageous cost price.

The first object of the present invention is therefore a device comprising a power cable and/or telecommunications cable and/or a cable accessory, characterized in that said cable and/or said cable accessory comprises at least one fire-resistant insulating layer based on a composite material comprising at least one cementing material representing from 5 to 95 wt % relative to the total weight of the composite material and at least one nonwoven fibrous material of pliable and flexible structure, and in that said layer is an inner layer of said cable or of said cable accessory.

A power cable and/or telecommunications cable generally comprises at least one elongated conductor and at least one insulating protective sheath.

A cable accessory such as a joint or a termination generally comprises an assembly of several layers of materials generally of the silicone rubber type, one or more reinforcing layers, for example one or more metal layers, as well as a fireproof outer protective sheath, for example an elastomer tape or a mica strip.

According to the invention, “inner layer” means a layer that does not constitute the outermost layer of the device, and more particularly:
in the case of a cable, a layer interposed between the elongated conductor and an insulating protective sheath, where said layer may or may not be in direct contact with the elongated conductor and
in the case of a joint or a termination, a layer interposed between the fireproof outer protective sheath and one of the layers of material of the silicone rubber type and/or one of the reinforcing layers, where said layer may or may not be in direct contact with said outer sheath.

In the present invention, the expression “cementing material” means a solid material comprising silicon (Si), aluminum (Al), oxygen (O) and at least one element selected from potassium (K), sodium (Na), lithium (Li), cesium (Cs) and calcium (Ca), said solid material being a geopolymer cement or being derived from a mixture consisting of an anhydrous cement and water.

Owing to the presence of the insulating layer, the device according to the invention displays good fire resistance while having good mechanical properties. In particular, the composite material included in the composition of the fire-resistant insulating layer is notably flexible enough to allow manipulation of the cable (e.g. winding, bending, twisting) without causing excessive deterioration of said layer that would result in a decrease in its cohesion and its fire resistance. Moreover, the fire-resistant insulating layer remains intact from room temperature to temperatures greater than or equal to 1000° C. for a time that may be up to 120 min, notably reached during a fire.

Advantageously, the device according to the invention satisfies at least any one of the following fire resistance standards: EN50200, IEC60331-11, IEC60331-21, IEC60331-23, IEC60331-25, DIN4102, NBN713020 addendum 3, EN50577, NFC32070 CR1 and BS6387CWZ.

Advantageously, the insulating layer based on the composite material defined above meets the fire resistance standard IEC 60331-11, with electric cables at a voltage of 20 kV at 775° C. for 60 minutes.

The layer of composite material preferably has a thickness in the range from about 0.2 to 10 mm, and preferably from about 0.5 to 6 mm.

According to a first embodiment of the invention, the cementing material is obtained from a mixture consisting of a conventional anhydrous cement and water. Hardening takes place as a result of hydration of calcium silicates and calcium aluminates.

The anhydrous cement may be Portland cement and in particular white cement, or slag and ash cement.

According to a second embodiment of the invention, the cementing material is a geopolymer cement.

In the present invention, the term geopolymer cement, or hardening of a geopolymer composition, indicates that hardening takes place by an internal reaction of the polycondensation type or of the hydrothermal type and that it is not the result of simple drying, as is generally the case for binders based on alkaline silicates.

In fact, the geopolymer cements result from a mineral polycondensation reaction by alkaline activation, called geosynthesis, in contrast to the traditional hydraulic binders in which hardening is the result of hydration of calcium aluminates and calcium silicates.

The geopolymer cement may be an aluminosilicate geopolymer cement.

The aluminosilicate geopolymer cement may be selected from the poly(sialates) corresponding to formula (I) Mₙ(—Si—O—Al—O—)ₙ [(M)-PS], the poly(sialate-siloxos) corresponding to formula (II) Mₙ(—Si—O—Al—O—Si—O—)ₙ [(M)-PPS], the poly(sialate-disiloxos) corresponding to formula (III) Mₙ(—Si—O—Al—O—Si—O—Si—O)ₙ [(M)-PSDS], formulas in which M represents at least one alkaline cation K, Na, Li, Cs or a mixture thereof, and n denotes the degree of polymerization. In the compound of formula (I) the Si/Al molar ratio is 1, in the compound of formula (II) the Si/Al molar ratio is 2, and in the compound of formula (III) it is 3.

The Si/Al molar ratio has an influence on the mechanical properties of the geopolymer cement, in particular its properties of resistance to mechanical stress (Young's modulus). According to a preferred embodiment of the invention, the geopolymer cement is selected from the compounds in which the Si/Al molar ratio varies from about 1.9 to 3 and even more preferably from about 1.9 to 2.5. By choosing these geopolymer cements it is possible to have a fire-resistant insulating layer that is flexible enough to allow the device according to the invention to be manipulated without causing cracking of the composite material.

According to the invention, the cementing material preferably represents from about 70 to 90 wt %, relative to the total weight of the composite material.

The nonwoven fibrous material included in the composition of the composite material of the fire-resistant insulating layer according to the invention may be selected from materials such as paper, in particular blotting paper; glass fibers; nonwoven materials manufactured from functionalized or nonfunctionalized cellulose; materials with a porous and/or fibrous matrix, in particular cellular polypropylene matrixes, matrixes with a cellular and/or fibrous structure manufactured from natural cellulose acetate fibers. According to a preferred embodiment of the invention, the nonwoven fibrous material is selected from the matrixes with a cellular and/or fibrous structure manufactured from natural cellulose acetate fibers.

The fibrous material may in particular be in the form of strip or tape.

According to a preferred embodiment of the invention, the fibrous material represents from about 5 to 95 wt %, and even more preferably from about 10 to 30 wt %, relative to the total weight of the composite material.

According to a particular, preferred embodiment of the invention, the composite material further comprises at least one organic additive with a polymer structure. This additive is intended to improve the cohesion of the composite material and its adhesion on the layer of the cable or accessory with which it is intended to be in contact. The organic additive with a polymer structure is preferably selected from polypropylene, in particular in the form of fibers; styrene-butadiene copolymers (SBR); styrene-butadiene-ethylene copolymers (EBS); derivatives of styrene-ethylene copolymers, notably those marketed by Kraton such as the styrene-ethylene-butylene-styrene copolymers (SEBS), styrene-butadiene-styrene copolymers (SBS), styrene-isoprene-styrene copolymers (SIS), styrene-propylene-ethylene copolymers (EPS) or styrene-ethylene-propylene-styrene copolymers (SEPS); copolymers of ethylene and vinyl acetate (EVA), crosslinked polyorganosiloxanes (e.g. using a peroxide); polyethylene optionally in the form of powder; lignosulfonates; cellulose and derivatives thereof such as cellulose acetate; and a mixture thereof.

When it is used, the polymer additive preferably represents from about 2 to 70 wt %, and even more preferably from about 30 to 50 wt %, relative to the total weight of the composite material, depending on the application and the required flexibility.

The layer comprising at least one cementing material may further comprise one or more additives selected from organic additives, inorganic additives and mixtures thereof. Among these additives we may quite particularly mention the agents that retard setting of the cement composition at room temperature and allow the latter to remain malleable for longer. Said retarders may notably be selected from ammonium, the alkali metals, the alkaline-earth metals, borax, the lignosulfonates and in particular the metal salts of calcium lignosulfonates, the celluloses such as carboxymethyl hydroxyethyl cellulose, the sulfoalkylated lignins for example sulfomethylated lignin, the hydroxycarboxylic acids, the copolymers of salts of 2-acrylamido-2-methylpropane sulfonic acid and of acrylic acid or of maleic acid, the saturated salts, and mixtures thereof.

According to an especially preferred embodiment of the invention, the retarder is selected from the lignosulfonates.

When it is used, the retarder preferably represents from about 5 to 60 wt %, and even more preferably from about 10 to 30 wt %, relative to the total weight of the composite material.

When the device according to the invention is a power cable and/or telecommunications cable according to the invention, the insulating protective sheath is preferably made of a halogen-free material. It may be produced conventionally starting from materials that retard flame propagation or resist flame propagation. Notably, if the latter do not contain halogen, the sheathing is said to be of the HFFR type (acronym for “halogen-free flame retardant”).

The electrically insulating sheath represents the outermost layer of the cable (i.e. it is also called the outer protective sheath).

It comprises at least one polymer material.

The choice of the polymer material is not limiting and they are familiar to a person skilled in the art.

According to a preferred embodiment of the invention, the polymer material is selected from the crosslinked and noncrosslinked polymers, and polymers of the inorganic type and organic type.

The polymer material may be a homopolymer or a copolymer having thermoplastic and/or elastomeric properties.

The polymers of the inorganic type may be polyorganosiloxanes.

The polymers of the organic type may be polyurethanes or polyolefins.

The polyolefins may be selected from the ethylene and propylene polymers. As examples of ethylene polymers, we may mention linear low-density polyethylene (LLDPE), low-density polyethylene (LDPE), medium-density polyethylene (MDPE), high-density polyethylene (HDPE), copolymers of ethylene and vinyl acetate (EVA), copolymers of ethylene and of butyl acrylate (EBA), of methyl acrylate (EMA), of 2-hexylethyl acrylate (2HEA), copolymers of ethylene and alpha-olefins for example polyethylene-octene (PEO), the ethylene/propylene copolymers (EPR), or the ethylene and propylene terpolymers (EPT) for example terpolymers of ethylene propylene diene monomer (EPDM).

Each power cable or telecommunications cable may comprise a plurality of elongated conductors, each comprising a fire-resistant layer of composite material as described above. In this case, the electrically insulating sheath surrounds the plurality of elongated conductors of each fire-resistant cable. In a particular embodiment, and although this is optional taking into account the presence of the fire-resistant insulating layer of composite material, each of the cables may further comprise at least one additional insulating layer between the fire-resistant insulating layer of composite material and the elongated electrically conducting element. Thus, in this case, the electrically insulating sheath surrounds the fire-resistant insulating layer of composite material and said fire-resistant insulating layer of composite material surrounds the elongated conductor. According to another embodiment, it is also possible to arrange a fire-resistant insulating layer of composite material between two sheaths, an outer sheath and an intermediate sheath that covers the cable core. Finally, according to yet another embodiment, it is possible to arrange two fire-resistant insulating layers of composite material when for example the cable comprises several insulating sheaths.

When it is present, the additional electrically insulating layer may comprise at least one polymer material selected from crosslinked and noncrosslinked polymers, and polymers of the inorganic type and organic type.

The polymer material may be a homopolymer or a copolymer having thermoplastic and/or elastomeric properties.

The polymer material is preferably not halogenated.

The polymers of the inorganic type may be polyorganosiloxanes.

The polymers of the organic type may be polyurethanes or polyolefins.

The polyolefins may be selected from ethylene and propylene polymers. As examples of ethylene polymers, we may mention linear low-density polyethylene (LLDPE), low-density polyethylene (LDPE), medium-density polyethylene (MDPE), high-density polyethylene (HDPE), the copolymers of ethylene and vinyl acetate (EVA), the copolymers of ethylene and butyl acrylate (EBA), of methyl acrylate (EMA), of 2-hexylethyl acrylate (2HEA), the copolymers of ethylene and of alpha-olefins for example polyethylene-octene (PEO), the ethylene and propylene copolymers (EPR), or the ethylene and propylene terpolymers (EPT), for example the terpolymers of ethylene propylene diene monomer (EPDM).

When it is present, the additional electrically insulating layer may further comprise fireproofing fillers and/or inert fillers (or incombustible filler).

The choice of the fireproofing fillers and/or inert fillers is not limiting and they are familiar to a person skilled in the art.

The fireproofing fillers may be selected from the hydrated fillers, notably from the metal hydroxides, for example magnesium dihydroxide (MDH) or aluminum trihydroxide (ATH), and other mineral fillers such as CaO or the phyllosilicates.

These fireproofing fillers act mainly by a physical mechanism, decomposing endothermically (e.g. liberation of water), which has the effect of lowering the temperature of the electrically insulating layer and limiting propagation of the flames along the cable. Notably flame retardant properties are referred to.

The inert fillers may be chalk, talc, clay (e.g. kaolin), carbon black, or carbon nanotubes.

The second object of the present invention is a method for manufacturing a device comprising a power cable and/or telecommunications cable and/or a cable accessory as defined according to the first object of the invention, said device comprising at least one fire-resistant insulating layer based on a composite material comprising at least one cementing material representing from 5 to 95 wt % relative to the total weight of the composite material and at least one nonwoven fibrous material of pliable and flexible structure, and optionally at least one polymer additive, said method being characterized in that it comprises at least the following steps:

i) a step of preparing a cement composition comprising:
at least one geopolymer composition or at least one mixture consisting of an anhydrous cement and water, and optionally
at least one polymer additive;

ii) a step of applying a nonwoven fibrous material of pliable and flexible structure:
either around one or more elongated conductors and/or around an inner layer of a power cable and/or telecommunications cable when the device is a cable, to obtain a cable/fibrous material assembly,
or around at least one of the inner layers of a joint or of a termination when the device is a cable accessory; to obtain a cable accessory/fibrous material assembly;

iii) a step of impregnating the cable/fibrous material or cable accessory/fibrous material assembly obtained above in the preceding step with said geopolymer composition;

iv) a step of hardening the geopolymer composition or mixture consisting of a conventional anhydrous cement and water (i.e. cement paste) impregnating said fibrous material, to form a fire-resistant insulating layer based on said composite material.

The method according to the invention is quick, simple and advantageous from an economic standpoint. It gives access to cables or cable accessories displaying good fire resistance.

The conventional anhydrous cement used in step i) is as defined in the first object of the invention.

The geopolymer composition in step i) is preferably an aluminosilicate geopolymer composition.

The geopolymer composition in step i) then preferably complies with the following molar composition (I):

w SiO₂:x Al₂O₃:y M₂O:z H₂O (I)

in which:
M is selected from Na, K, Li, Cs and a mixture thereof,
w is a value between about 0.1 and 8,
x is a value between about 0.1 and 0.3,
y is a value between about 0.05 and 0.2,
z is a value between about 0.8 and 3,

said composition comprising from about 40 to 79 wt % of solid materials (SiO₂, Al₂O₃, M₂O), relative to the total weight of said composition.

The solids/water weight ratio in said geopolymer composition determines the kinetics of solidification in step iv). According to a preferred embodiment of the invention, the solids/water weight ratio varies from about 0.6 to 1.65, and even more preferably from about 0.85 to 1.40. Said weight ratio makes it possible to have a fairly fluid cement composition to allow impregnation of the fibrous material, and with fairly slow solidification kinetics to allow application of the fibrous material before it solidifies.

Step i) is generally carried out at high pH, notably in the range from 10 to 13.

When the cement composition is an aluminosilicate geopolymer composition, step i) preferably comprises the following substeps:
i₁) a step of preparing an aqueous solution of alkaline silicate with SiO₂/M₂O molar ratio from about 1.65 to 3.4, where the concentration by weight of the alkaline silicate in water may range from about 35 to 90%, and
i₂) a step of mixing an aluminosilicate in the form of powder, with Al₂O₃/SiO₂ molar ratio in the range from 0.4 to 0.8 with the aqueous solution of alkaline silicate prepared in the preceding step, where the concentration by weight of the aluminosilicate in the aqueous solution of alkaline silicate prepared in the preceding step may range from about 10 to 80%, and preferably from about 25% to 65%.

The aluminosilicate may be selected from the metakaolins (i.e. calcined kaolins), fly-ash, blast-furnace slag, swelling clays such as bentonite, calcined clays, any type of compound comprising aluminum and fumed silica, zeolites and a mixture thereof. Among these compounds, the aluminosilicates marketed by the company Imérys such as metakaolin are preferred.

The aqueous solution of alkaline silicate may be prepared by mixing silicon dioxide SiO₂ or an alkaline silicate with a base MOH in which M is K or Na.

Silicon dioxide SiO₂ may be selected from fumed silica (i.e. pyrogenic silica), quartz, and mixtures thereof.

The alkaline silicate may be selected from the sodium silicates, potassium silicates and a mixture thereof. The alkaline silicates marketed by the company Silmaco or by the company PQ Corporation are preferred.

The base MOH may be selected from KOH, NaOH and mixtures thereof.

Step i₁) may be carried out by dissolving the base in water, leading to release of heat (exothermic reaction), and then adding silica (or alkaline silicate). The heat released then accelerates dissolution of the silica (or of the alkaline silicate) in step i₁) and aluminosilicate in step i₂) and thus setting of the geopolymer composition.

At the end of step i₂), the geopolymer composition has a viscosity that increases over time when it is exposed to the open air.

According to a preferred embodiment of the invention, and when the device is a power cable or a transmission cable, the nonwoven fibrous material of pliable and flexible structure is in the form of tape or strip and step ii) of application of said fibrous material is then carried out by winding said tape or said strip around one or more elongated conductors or around an inner layer of said cable, and moreover said winding may be carried out with overlaps.

According to a particular embodiment of the invention, and when the device is a power cable or a transmission cable, the method may further comprise an additional step, before, during or after step iv), of making an insulating protective sheath around the layer consisting of said fibrous material impregnated with the cement composition.

This outer protective sheath may notably be made by extrusion.

Step iv) is generally carried out at room temperature, since polymerization (in the case of formation of the geopolymer cement) or hydration (in the case of formation of the cementing material obtained from a mixture consisting of a conventional anhydrous cement and water) takes place at room temperature.

The hardening rate in step iv) may be from about 30 to 300 minutes at about 25° C. (i.e. at room temperature).

However, it is entirely possible for the hardening in step iv) to be retarded by adding at least one setting retarder to the geopolymer composition. As pointed out above, the retarder is preferably selected from the lignosulfonates.

The following examples illustrate the present invention. They do not in any way limit the overall scope of the invention as presented in the claims. The ratios of the oxides are molar ratios and the percentages given are percentages by weight.

### EXAMPLES

The raw materials used in the examples are listed below:
Sodium silicate of the “waterglass” type, Simal, of formula Na₂O.2SiO₂, with SiO₂/Na₂O molar ratio of about 2,
Running water,
Potassium hydroxide, Sigma Aldrich, of purity >85%,
Aluminosilicate sold under the trade name PoleStar® 200R, by the company Imérys, with Al₂O₃/SiO₂ molar ratio of 41/55 (i.e. about 0.745),
Polypropylene fibers sold under the trade name CELLOTIN PP6 by the company ZSCHIMMER & SCHWARZ.

Unless stated otherwise, all these raw materials were used as received from the manufacturers.

### Example 1: Manufacture of a Fire-Resistant Cable According to the Invention

### 1.1. Preparation of a Geopolymer Composition (Step i)

A solution of alkaline silicate was prepared by mixing 36 g of sodium silicate, 20 g of water and 8 g of potassium hydroxide. Then 39 g of aluminosilicate and 2.2 g of polypropylene fibers were mixed with the aqueous solution of alkaline silicate.

Said composition had a solids content of about 80 wt %. It was used immediately in the next step.

### 1.2. Manufacture of a Fire-Resistant Cable

Two cable designs were assessed:
an assembly of 2 copper conductors each having a cross section of 1.5 mm², designated Assembly 1;
an assembly of 4 copper conductors each having a cross section of 1.5 mm², designated Assembly 2.

The conductors were assembled according to a defined pairing pitch. Nonwoven paper tape having a thickness of 0.2 mm and a width of 30 mm was wound or laid lengthwise around each of the assemblies 1 and 2.

Each of the assemblies 1 and 2 was then impregnated by dip coating in the geopolymer composition prepared above in the preceding step.

Each of the assemblies 1 and 2 was then covered by hot extrusion with a protective polymer sheath based on a mixture of linear low-density polyethylene (LLDPE) and EVA and comprising 63 wt % of inorganic fireproofing fillers (alumina trihydrate (ATH) and CaCO₃) having a thickness of 1.03 mm. Power cables were thus obtained, CE1 and CE2 respectively, comprising a fire-resistant layer based on a composite material as defined in the first object of the invention.

### 1.3. Cable Performance

The cables CE1 and CE2 thus obtained were evaluated with respect to their fire resistance performance. The assembly was placed in a furnace and exposed to a temperature close to 1000° C. for a period varying from 30 min to 2 hours (standard DIN 4102-12).

The cables CE1 and CE2 were also tested for their flame resistance performance by the method recommended by standard EN 50200, i.e. by directly exposing the cables CE1 and CE2 to the flame of a propane burner, giving a constant temperature of nominal theoretical attack of 842° C.

The cables according to the invention gave a fire resistance of 90 min (E90) according to standard DIN 4102-12 and of 121 minutes according to standard EN 50200.

For comparison, a cable not according to the invention (CE3), prepared by an identical method, but not comprising a layer of composite material based on the geopolymer composition, was also tested with respect to its fire resistance performance according to standard DIN 4102-12. The cable CE3 showed a fire resistance of only 31 min.

For comparison, another cable not according to the invention (CE4), prepared by an identical method, but in which the layer of composite material based on the geopolymer composition was replaced with aluminum tape with a thickness of 25 μm, was also tested with respect to its flame resistance performance according to standard EN 50200. The cable CE4 showed a fire resistance of only 17 min.

Consequently, these tests demonstrate that the presence of the layer of composite material makes it possible to improve the fire resistance and flame resistance of the cables very significantly.

1. A device comprising:
a power cable and/or telecommunications cable and/or a cable accessory,
wherein said cable and/or said cable accessory has at least one fire-resistant insulating layer based on a composite material having at least one cementing material representing from 5 to 95 wt % relative to the total weight of the composite material and at least one nonwoven fibrous material of pliable and flexible structure,
and in that said layer is an inner layer of said cable or of said cable accessory.

2. The device as claimed in claim 1, wherein the cementing material is a solid material comprising silicon (Si), aluminum (Al), phosphate (P), oxygen (O) and at least one element selected from potassium (K), sodium (Na), lithium (Li), cesium (Cs) and calcium (Ca), said solid material being a geopolymer cement or being obtained from a mixture made of an anhydrous cement and water.

3. The device as claimed in claim 1, wherein the layer of composite material has a thickness ranging from 0.2 to 10 mm.

4. The device as claimed claim 1, wherein the cementing material is an aluminosilicate geopolymer cement.

5. The device according to claim 1, wherein the geopolymer cement is selected from the compounds in which the Si/Al molar ratio varies from 1.9 to 3.

6. The device according to claim 1, wherein the anhydrous cement is white cement or slag and ash cement.

7. The device according to claim 1, wherein the cementing material represents from 70 to 90 wt % relative to the total weight of the composite material.

8. The device according to claim 1, wherein the nonwoven fibrous material is selected from paper, glass fibers, nonwoven materials manufactured from functionalized or nonfunctionalized cellulose, cellular polypropylene matrixes and matrixes with a cellular and/or fibrous structure manufactured from natural cellulose acetate fibers.

9. The device according to claim 1, wherein the fibrous material is in the form of strip or tape.

10. The device according to claim 1, wherein the fibrous material represents from 5 to 95 wt % relative to the total weight of the composite material.

11. The device according to claim 1, wherein the composite material further comprises at least one organic additive with a polymer structure.

12. The device as claimed in claim 11, wherein the polymer additive is selected from polypropylene, the styrene-butadiene copolymers; styrene-butadiene-ethylene copolymers; derivatives of styrene-ethylene copolymers; copolymers of ethylene and vinyl acetate, crosslinked polyorganosiloxanes; polyethylene; lignosulfonates; cellulose and derivatives thereof; and a mixture thereof.

13. The device as claimed in claim 11, wherein the polymer additive represents from 2 to 70 wt %, relative to the total weight of the composite material.

14. The device according to claim 1, wherein the layer comprising at least one cementing material further comprises one or more agents that retard setting of the cement composition at room temperature.

15. The device as claimed in claim 14, wherein the retarder is selected from the lignosulfonates.

16. The device as claimed in claim 14, wherein the retarder represents from 5 to 60 wt %, relative to the total weight of the composite material.

17. A method for manufacturing a device that has a power cable and/or a telecommunications cable and/or a cable accessory as defined in claim 1, said device having at least one fire-resistant insulating layer based on a composite material having at least one cementing material representing from 5 to 95 wt % relative to the total weight of the composite material and at least one nonwoven fibrous material of pliable and flexible structure,
and optionally at least one polymer additive,
said method comprising the steps of:
i) a step of preparing a cement composition comprising:
at least one geopolymer composition or at least one mixture consisting of an anhydrous cement and water, and optionally
at least one polymer additive;
ii) a step of applying a nonwoven fibrous material of pliable and flexible structure:
either around one or more elongated conductors or around an inner layer of a power cable and/or telecommunications cable when the device is a cable, to obtain a cable/fibrous material assembly,
or around at least one of the inner layers of a joint or of a termination when the device is a cable accessory; to obtain a cable accessory/fibrous material assembly;
iii) a step of impregnating the cable/fibrous material or cable accessory/fibrous material assembly obtained above in the preceding step with said geopolymer composition;
iv) a step of hardening the geopolymer composition or mixture consisting of a conventional anhydrous cement and water impregnating said fibrous material, to form a fire-resistant insulating layer based on said composite material.

18. The method as claimed in claim 17, wherein the geopolymer composition in step i) is an aluminosilicate geopolymer composition having the following molar composition (I):
w SiO₂:x Al₂O₃:y M₂O:z H₂O (I)
in which:
M is selected from Na, K, Li, Cs and a mixture thereof,
w is a value between about 0.1 and 8,
x is a value between about 0.1 and 0.3,
y is a value between about 0.05 and 0.2,
z is a value between about 0.8 and 3,
said composition having from 40 to 79 wt % of solid materials relative to the total weight of said composition.

19. The method as claimed in claim 18, having the solids/water weight ratio in said geopolymer composition varies from 0.6 to 1.65.

20. The method as claimed in claim 18, wherein step i) comprises the following substeps:
i₁) a step of preparing an aqueous solution of alkaline silicate of SiO₂/M₂O molar ratio ranging from 1.65 to 3.4, the concentration by weight of the alkaline silicate in water ranging from 35 to 90%, and
i₂) a step of mixing an aluminosilicate in the form of powder, with Al₂O₃/SiO₂ molar ratio ranging from 0.4 to 0.8, with the aqueous solution of alkaline silicate prepared in the preceding step, where the concentration by weight of the aluminosilicate in the aqueous solution of alkaline silicate prepared in the preceding step may vary from 10 to 80%.

21. The method as claimed in claim 17, wherein the device is a power cable or a transmission cable, and in that the nonwoven fibrous material of pliable and flexible structure is in the form of tape or strip and step ii) of application of said fibrous material is then carried out by winding said tape or said strip around one or more elongated conductors or around an inner layer of said cable, where said winding may moreover be carried out with overlaps.

22. The method as claimed in claim 17, wherein the device is a power cable or a transmission cable, and in that the method further comprises an additional step, before, during or after step iv), of making an insulating protective sheath around the layer made of said fibrous material impregnated with the cement composition.
